(19) United States
(12) Patent Application Publication
(10) Pub. No.: US 2017/0135320 A1
(43) Pub. Date: May 18, 2017

(54) ROTATING LIGHT FOR A PET COLLAR

(71) Applicant: Victoria Efferen, Harrison, NY (US)

(72) Inventor: Victoria Efferen, Harrison, NY (US)

(21) Appl. No.: 15/355,721

(22) Filed: Nov. 18, 2016

Related U.S. Application Data
(60) Provisional application No. 62/257,040, filed on Nov. 18, 2015.

(51) Int. Cl. A01K 27/00; F21V 21/088; F21V 21/08; F21V 21/30; F21V 23/04

(52) U.S. Cl. CPC A01K 27/006; A01K 27/009; F21V 21/30; F21V 23/04; F21V 21/08; F21V 21/088

(57) ABSTRACT

Exemplary embodiments of a pet collar and light for a pet collar are provided. In one embodiment, a light mechanism is provided for attachment to a pet collar, including a housing having a securing mechanism on a first side, a pivoting mechanism provided on a second opposing side of the housing, the pivoting mechanism having a first end and a second opposing end, and a switch having a light, a first end and a second opposing end, wherein the first end of the switch is engaged to the first end of the pivoting mechanism and the second end of the switch is engaged to the second end of the pivoting mechanism.

### FIELD OF THE DISCLOSURE

The present disclosure relates to exemplary embodiments of a rotating light for a pet collar, and more particularly, to a housing having a rotating light that can be engaged to a pet collar or harness.

### BACKGROUND

When walking their pets at night or when lighting conditions are poor, pet owners must carry a flashlight or other lighting device with them. This can be difficult when the pet owner is also holding a leash for the pet with one hand and is carrying other items, such as a phone, umbrella or bags for pet feces in the other hand. Therefore, there is a need for a lighting device for a pet collar or harness that can provide stable lighting for a pet and a pet owner without the need for a pet owner to hold a flashlight.

### SUMMARY OF EXEMPLARY EMBODIMENTS OF THE PRESENT DISCLOSURE

At least some of the above described problems can be addressed by exemplary embodiments of the apparatuses and methods according to the present disclosure. For example, using such exemplary embodiments, it is possible to provide a light mechanism for attachment to a pet collar, comprising a housing having a securing mechanism on a first side, a pivoting mechanism provided on a second opposing side of the housing, the pivoting mechanism having a first end and a second opposing end, and a switch having a light, a first end and a second opposing end, wherein the first end of the switch is engaged to the first end of the pivoting mechanism and the second end of the switch is engaged to the second end of the pivoting mechanism.

The securing mechanism can further comprise a first bar approximate a first end of the first side of the housing, and a second bar approximate a second opposing end of the first side of the housing, wherein the first bar defines a first elongated slot between the first bar and the first side of the housing and the second bar defines a second elongated slot between the second bar and the first side of the housing, and wherein a strap of a pet collar or harness can be provided through the first and second elongated slots to attach the light mechanism to the strap. In some exemplary embodiments, the first and second bars can be permanently fixed to the housing. In some exemplary embodiments, at least one of the first bar and the second bar is detachable from the housing of the light mechanism to allow the first bar or the second bar to be opened and closed to secure the housing to the strap.

The second end of the housing can further comprise a label area for providing information including a pet's name, owner's name or owner's address. The light mechanism can further comprise a power button provided on the switch to turn the light on or off. In some exemplary embodiments, the pivoting mechanism can define an axis between the first end and the second opposing end of the pivoting mechanism, and the switch can rotate about the axis with respect to the housing. The light can be in a fixed position on the switch, and rotation of the switch along the axis can change the direction of the light. In some exemplary embodiments, the switch can rotate up to 180 degrees about the axis with respect to the housing. The switch can be configured to disengage from the housing. In some exemplary embodiments, the switch disengages from the housing along the pivoting mechanism.

These and other objects, features and advantages of the present disclosure will become apparent upon reading the following detailed description of embodiments of the present disclosure, when taken in conjunction with the appended claims. It should be understood that the detailed description and specific examples, while indicating the preferred or exemplary embodiments of the disclosure, are intended for purposes of illustration only and are not intended to limit the scope of the disclosure.

### BRIEF DESCRIPTION OF THE DRAWINGS

The foregoing and other exemplary objects of the present disclosure will be apparent upon consideration of the following detailed description, taken in conjunction with the accompanying exemplary drawings and claims, in which like reference characters refer to like parts throughout, and in which:

FIG. 1 is an illustration of a front perspective view of a light mechanism engaged to a pet collar according to an exemplary embodiment of the present disclosure;

FIG. 2 is an illustration of a front perspective view of a light mechanism according to an exemplary embodiment of the present disclosure; and

FIG. 3 is an illustration of a rear perspective view of a light mechanism according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

The exemplary embodiments of the present disclosure can provide for various configurations of a light mechanism for a pet collar or a pet harness. In some exemplary embodiments, the light mechanism can have a housing that can be engaged to a pet collar or harness and connected to a light that is rotatably engaged with the housing. Exemplary embodiments of the light mechanism will now be described with reference to the figures.

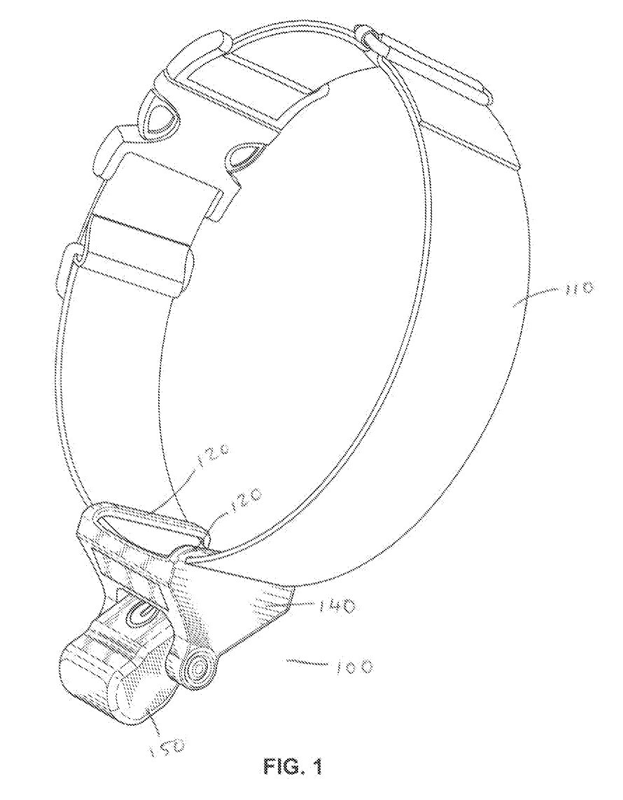

FIG. 1 is an illustration of a front perspective view of a light mechanism 100 engaged with a pet collar 110 according to an exemplary embodiment of the present disclosure. The light mechanism 100 can have a housing 140 and a switch 150. The housing 140 can have one or more bars 120 that can be integral with or connected to the housing 140 through which the pet collar 110 (or strap of a pet collar or harness) can extend through to engage the light mechanism 100 with the pet collar 110, as will be explained below.

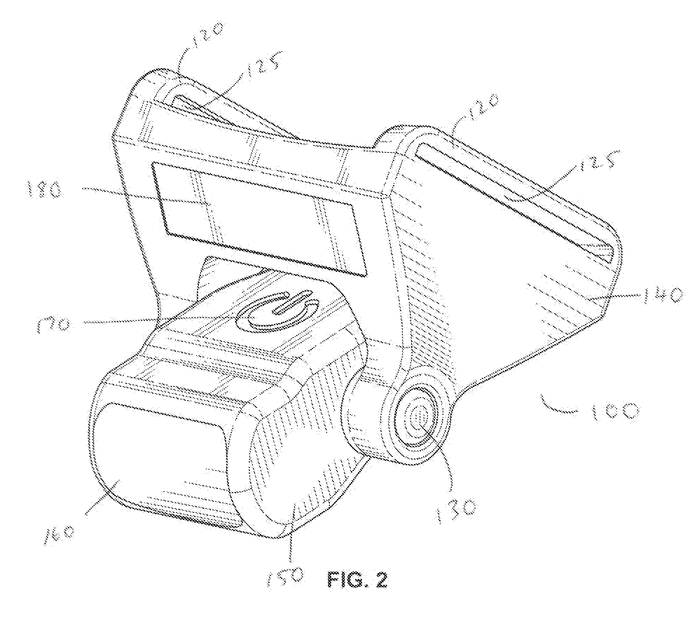

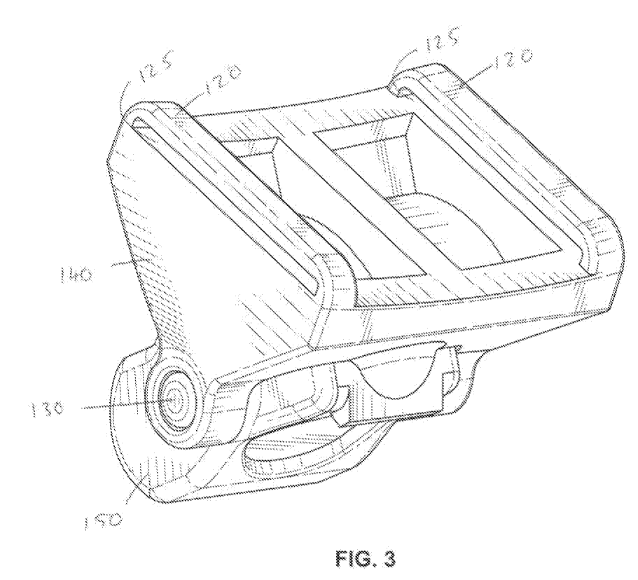

FIG. 2 is an illustration of a front perspective view of a light mechanism 100 according to an exemplary embodiment of the present disclosure, and FIG. 3 is an illustration of a rear perspective view of a light mechanism 100 for a pet collar according to an exemplary embodiment of the present disclosure. As can be seen in FIGS. 2 and 3, the housing 140 can have one or more bars 120 having elongated slots 125 through which a strap of a pet collar or harness can be inserted to engage the housing on the pet collar or harness. In the embodiment shown, two bars 120 are provided on opposite ends of the housing 140, but are not limited to any particular location. In some exemplary embodiments, one bar 120 can be provided in approximately a middle location of the housing 140, and in some embodiments, more than two bars 120 can be provided on the housing 140. Other engagement mechanisms can be used to engage the housing to the pet collar and are not limited to the bars 120 described herein. The bars 120 can be integral with the housing, attached to the housing, or removable from the housing 140. In some exemplary embodiments, the bars 120 can open and close to receive the pet collar 110, and can be clips or other mechanisms that allow the bars 120 to open and close to receive the pet collar or harness. For example, in some exemplary embodiments, each bar 120 can be fixed on one end (e.g., a pivoting end) and can be opened on a second end to allow attachment of the housing 140 on the pet collar or harness.

The housing 140 can have a label area 180 that can be used for but not limited to, e.g., a logo, design, pet's name, address, owner information, contact number, etc. The information can be engraved or etched permanently on the label area 180, or can be provided on a permanent or removable label that affixes to the label area 180. The label area 180 can be recessed within the housing 140. The housing 140 can further have a pivoting mechanism 130 that is connected to a switch 150. The switch 150 can be connected to the pivoting mechanism 130 at opposite ends of the switch 150. A light 160 can be provided on the switch 150. The light 160 can have a cover, which can be transparent. The light 160 can contain one or more bulbs, such as an LED or other type of light, which is placed within the switch 150.

A power button 170 can be provided on the switch 150 that turns the light 160 on or off. In some exemplary embodiments, the power button 170 can also be located on the housing 140, with appropriate wiring. The power button 170 can also be activated by a remote, or a mobile electronic device, through a software application on a mobile electronic device, Bluetooth®, or other wireless system. A battery for the light 160 can be provided with the appropriate circuity within the switch 150. In some exemplary embodiments, the battery can be rechargeable. The pivoting mechanism 130 allows the light 160 to rotate about the axis of the pivoting mechanism 130, allowing the direction of the light to be changed. For example, the light can be provided on the ground or in front of the pet when the pet is walking. This can be adjusted to various pets based on height or size of the pet, and can be rotated so that is does not shine on the pet's face and is rotated to provide light to the pet and to the owner in front of the pet when walking the pet. The switch 150 can be rotated up to 180 degrees of movement with respect to the housing 140. In some exemplary embodiments, the switch 150 can be rotated up to 360 degrees (e.g., can circle about the pivoting axis). In some exemplary embodiments, the switch 150 can be removable or disconnected from the housing (e.g., disengaged from the pivoting mechanism 130). This can allow the user to replace or recharge the battery or bulb in the switch 150.

Various other considerations can also be addressed in the exemplary applications described according to the exemplary embodiments of the present disclosure. For example, various materials may be used to construct the light mechanism 100, including various materials for the housing and the switch. Different lights can be used, such as LED lights. Various sizes of the light mechanism 100 can be provided for various size pets. Various sizes, shapes and designs of the light mechanism 100 can be provided. Various other changes can be made, such as placement or positioning of the light, placement or positioning of the battery housing unit, positioning or design of the housing unit, positioning or design of any switches, rotation axis of the light or the light housing unit, battery quantity or type or bulb quantity or type. Various additions can be added to the light mechanism, such as a global positioning system (“GPS”) device, or remote control devices.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure.

What is claimed is:

1. A light mechanism for attachment to a pet collar, comprising:
a housing having a securing mechanism on a first side;
a pivoting mechanism provided on a second opposing side of the housing, the pivoting mechanism having a first end and a second opposing end; and
a switch having a light, a first end and a second opposing end;
wherein the first end of the switch is engaged to the first end of the pivoting mechanism and the second end of the switch is engaged to the second end of the pivoting mechanism.

2. The light mechanism of claim 1, wherein the securing mechanism further comprises:
a first bar approximate a first end of the first side of the housing; and
a second bar approximate a second opposing end of the first side of the housing;
wherein the first bar defines a first elongated slot between the first bar and the first side of the housing and the second bar defines a second elongated slot between the second bar and the first side of the housing; and
wherein a strap of a pet collar or harness can be provided through the first and second elongated slots to attach the light mechanism to the strap.

3. The light mechanism of claim 2, wherein the first and second bars are permanently fixed to the housing.

4. The light mechanism of claim 2, wherein at least one of the first bar and the second bar is detachable from the housing of the light mechanism to allow the first bar or the second bar to be opened and closed to secure the housing to the strap.

5. The light mechanism of claim 1, wherein the second end of the housing further comprises:
a label area for providing information including a pet's name, owner's name or owner's address.

6. The light mechanism of claim 1, further comprising:
a power button provided on the switch to turn the light on or off

7. The light mechanism of claim 1, wherein the pivoting mechanism defines an axis between the first end and the second opposing end of the pivoting mechanism, and the switch rotates about the axis with respect to the housing.

8. The light mechanism of claim 7, wherein the light is in a fixed position on the switch, and rotation of the switch along the axis changes the direction of the light.

9. The light mechanism of claim 8, wherein the switch can rotate up to 180 degrees about the axis with respect to the housing.

10. The light mechanism of claim 1, wherein the switch is configured to disengage from the housing.

11. The light mechanism of claim 10, wherein the switch disengages from the housing along the pivoting mechanism.
